(19) United States
(12) Patent Application Publication
(10) Pub. No.: US 2017/0131381 A1
(43) Pub. Date: May 11, 2017

(54) ENHANCING ANGLE OF ARRIVAL AND ANGLE OF DEPARTURE ESTIMATION BY SIGNALING DEVICE MOVEMENT

(71) Applicant: QUALCOMM Incorporated, San Diego, CA (US)

(72) Inventors: Rahul Malik, San Diego, CA (US); Carlos Horacio Aldana, Mountain View, CA (US)

(21) Appl. No.: 15/346,529

(22) Filed: Nov. 8, 2016

Related U.S. Application Data
(60) Provisional application No. 62/253,035, filed on Nov. 9, 2015.
(60) Provisional application No. 62/278,859, filed on Jan. 14, 2016.

(51) Int. Cl. G01S 3/50; H04W 64/00

(52) U.S. Cl. CPC G01S 3/50; H04W 64/006; H04W 84/12

(57) ABSTRACT

Aspects of the present disclosure may compensate for movements of a transmitting device when estimating angular information of wireless signals transmitted by the transmitting device. In some aspects, a receiving device may detect a movement of the transmitting device, and determine the angular information of the wireless signals based at least in part on the movement of the transmitting device. The wireless signals may include a first signal received at a first time and a second signal received at a second time, and the angular information may be determined based on the movement of the transmitting device from the first time to the second time. For example, the receiving device may determine the angular information based on the first signal, and may adjust the angular information based on the second signal if the movement of the transmitting device exceeds a threshold distance.

### CROSS-REFERENCE TO RELATED APPLICATIONS

This application claims priority under 35 USC 119(e) to co-pending and commonly owned U.S. Provisional Patent Application No. 62/253,035 entitled “ENHANCING ANGLE OF ARRIVAL AND ANGLE OF DEPARTURE ESTIMATION BY SIGNALING DEVICE MOVEMENT” filed on Nov. 9, 2015 and to co-pending and commonly owned U.S. Provisional Patent Application No. 62/278,859 entitled “ENHANCING ANGLE OF ARRIVAL AND ANGLE OF DEPARTURE ESTIMATION BY SIGNALING DEVICE MOVEMENT” filed on Jan. 14, 2016, the entireties of both of which are incorporated by reference herein.

### TECHNICAL FIELD

Aspects of the present disclosure relate generally to wireless networks, and specifically to estimating the angle of arrival and angle of departure of signals in wireless networks.

### INTRODUCTION

Angle of arrival (AoA) and angle of departure (AoD) information of wireless signals transmitted between devices may be estimated and thereafter used to determine the relative position and orientation of the devices. For example, signals may be received by a first device from a second device, and the first device may use AoA and/or AoD information of the received signals to determine a line of bearing with respect to the second device. If the location and orientation of the second device is known, then the first device may determine its position and orientation relative to the second device.

Because estimating AoA and AoD information is a passive positioning technique (e.g., the first device does not need to transmit any signals to the second device), and the first device may consume less power and bandwidth compared to devices that perform active positioning operations (e.g., such as active ranging operations using fine timing measurement (FTM) frames). In addition, because passive positioning operations based on estimating AoA and AoD information may be performed without capturing time of arrival (TOA) or time of departure (TOD) information, the accuracy of passive positioning operations is not dependent upon timing synchronization between the devices or processing delays associated with the devices.

Because positioning operations are becoming increasingly important for device location and tracking in wireless networks, it would be desirable to improve the accuracy of estimated AoA and AoD information without sacrificing performance.

### SUMMARY

This Summary is provided to introduce in a simplified form a selection of concepts that are further described below in the Detailed Description. This summary is not intended to identify key features or essential features of the claimed subject matter, nor is it intended to limit the scope of the claimed subject matter.

Apparatuses and methods for determining angular information of wireless signals are disclosed herein. In one aspect, a method is disclosed. The method may be performed by a receiving device, and may include receiving wireless signals from a transmitting device; detecting a movement of the transmitting device; and determining angular information of the wireless signals based at least in part on the movement of the transmitting device.

In another aspect, a receiving device is disclosed. The receiving device may include one or more processors and a memory. The memory may include instructions that, when executed by the one or more processors, cause the receiving device to receive wireless signals from a transmitting device; detect a movement of the transmitting device; and determine angular information of the wireless signals based at least in part on the movement of the transmitting device.

In another aspect, a non-transitory computer-readable medium is disclosed. The non-transitory computer-readable medium may comprise instructions that, when executed by a receiving device, cause the receiving device to perform a number of operations. The number of operations may include receiving a wireless signal from a transmitting device; detecting a movement of the transmitting device; and determining angular information of the wireless signals based at least in part on the movement of the transmitting device.

In another aspect, a receiving device is disclosed. The receiving device may include means for receiving a wireless signal from a transmitting device; means for detecting a movement of the transmitting device; and means for determining angular information of the wireless signals based at least in part on the movement of the transmitting device.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless system within which aspects of the present disclosure may be implemented.

FIG. 2 shows a block diagram of a wireless device in accordance with aspects of the present disclosure.

FIG. 3A is an illustration depicting reception of a wireless signal by a receiving device with two antennas.

FIG. 3B is an illustration depicting transmission of a wireless signal by a transmitting device with two antennas.

FIG. 3C is an illustration depicting example transmissions of wireless signals by a moving transmitting device.

FIG. 4A shows an example packet within which aspects of the present disclosure may be implemented.

FIG. 4B shows another example packet within which aspects of the present disclosure may be implemented.

FIG. 5A shows an example frame within which aspects of the present disclosure may be implemented.

FIG. 5B shows a very high throughput (VHT) preamble within which aspects of the present disclosure may be implemented.

FIG. 5C shows a high efficiency (HE) preamble within which aspects of the present disclosure may be implemented.

FIG. 6 is a flow chart depicting an example operation for determining angular information of wireless signals according to aspects of the present disclosure.

FIG. 7 is a flow chart depicting an example operation for selectively adjusting the angular information of wireless signals based at least in part on movement of a transmitting device.

FIG. 8 is a flow chart depicting an example operation for detecting movement of a transmitting device based on angular information of received wireless signals.

### DETAILED DESCRIPTION

Aspects of the present disclosure are described below in the context of estimating angle of arrival (AoA) and angle of departure (AoD) information for devices deployed in a wireless local area network (WLAN) for simplicity only. It is to be understood that aspects of the present disclosure are equally applicable to estimating AoA and/or AoD information for devices deployed in other wireless networks (e.g., cellular networks, personal area networks, pico networks, femto networks, satellite networks). As used herein, the terms “WLAN” and “Wi-Fi®” may include communications governed by the IEEE 802.11 family of standards, Bluetooth, HiperLAN (a set of wireless standards, comparable to the IEEE 802.11 standards, used primarily in Europe), and other technologies having relatively short radio propagation range. Thus, the terms “WLAN” and “Wi-Fi” may be used interchangeably herein. In addition, although described below in terms of an infrastructure WLAN system including an AP and a plurality of STAs, aspects of the present disclosure are equally applicable to other WLAN systems including, for example, WLANs including a plurality of APs, peer-to-peer (or Independent Basic Service Set) systems, Wi-Fi Direct systems, and/or Hotspots. Further, although described herein in terms of exchanging data packets between wireless devices, aspects of the present disclosure may be applied to the exchange of any data unit, packet, and/or frame between wireless devices. Thus, the term “data packet” may include any frame, packet, or data unit such as, for example, protocol data units (PDUs), MAC protocol data units (MPDUs), and physical layer convergence procedure protocol data units (PPDUs). The term “A-MPDU” may refer to aggregated MPDUs. The PDUs and/or PPDUs may include a physical-layer (PHY) service data unit (PSDU), which in turn may contain encapsulated data such as, for example, a MAC service data unit (MSDU) or a MAC frame.

Further, as used herein, the term “HT” may refer to a high throughput frame format or protocol defined, for example, by the IEEE 802.11n standards; the term “VHT” may refer to a very high throughput frame format or protocol defined, for example, by the IEEE 802.11ac standards; the term “HE” may refer to a high efficiency frame format or protocol defined, for example, by the IEEE 802.11ax standards; and the term “non-HT” may refer to a legacy frame format or protocol defined, for example, by the IEEE 802.11a/g standards. Thus, the terms “legacy” and “non-HT” may be used interchangeably herein. In addition, the term “legacy device” as used herein may refer to a device that operates according to the IEEE 802.11a/g standards, and the term “HE device” as used herein may refer to a device that operates according to the IEEE 802.11ax and/or 802.11az standards.

In the following description, numerous specific details are set forth such as examples of specific components, circuits, and processes to provide a thorough understanding of the present disclosure. The term “coupled” as used herein means connected directly to or connected through one or more intervening components or circuits. The term “angular information” as used herein may refer to AoA information and/or AoD information. Also, in the following description and for purposes of explanation, specific nomenclature is set forth to provide a thorough understanding of the present disclosure. However, it will be apparent to one skilled in the art that these specific details may not be required to practice the example implementations. In other instances, well-known circuits and devices are shown in block diagram form to avoid obscuring the present disclosure. The present disclosure is not to be construed as limited to specific examples described herein but rather to include within their scopes all implementations defined by the appended claims.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), assessing (e.g., assessing data in a memory) and the like. Also, “determining” may include resolving, selecting, choosing, establishing and the like. Also, “determining” may include measuring, estimating, and the like.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any such list including multiples of the same members (e.g., any lists that include aa, bb, or cc).

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims. Also, the example wireless communications devices may include components other than those shown.

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

As mentioned above, a receiving device may use AoA and/or AoD information of signals received from a transmitting device to determine its position and/or orientation relative to the transmitting device. Recent revisions to the IEEE 802.11 family of standards provide mechanisms for a transmitting device to provide its location and orientation to a number of receiving devices. This information may assist the receiving devices to determine their positions based on AoA information and/or AoD information of signals received from the transmitting device. Some receiving devices may estimate AoA and/or AoD information for a plurality of signals over a time period, for example, to continually or periodically refine the estimated AoA and/or AoD information—thereby improving device orientation and position estimates. One or more of the transmitting and/or receiving devices may be mobile devices, and therefore may move or change positions between successive wireless signal transmissions. The movements of the transmitting and/or receiving devices may affect the accuracy of AoA and/or AoD estimates of wireless signals communicated between the devices. These are at least some of the technical problems to be solved by various aspects of the present disclosure.

The apparatuses and methods disclosed herein may improve the accuracy with which a receiving device may estimate AoA and/or AoD information of signals received from a transmitting device by allowing the transmitting device to indicate changes to its position (e.g., movement from one location to another location). For example, a transmitting device may determine that it has moved by more than a threshold distance since a previous signal transmission to a receiving device, and then indicate its positional change to the receiving device. The indication (hereinafter referred to as a “movement indicator”) may inform the receiving device(s) that prior AoA and/or AoD estimates may not accurately reflect the transmitting device's current position. Alternatively, or in addition, a receiving device may detect the movement of the transmitting device by comparing previous AoA and/or AoD estimates (e.g., when the transmitting device was located at a previous position) with current AoA and/or AoD estimates (e.g., when the transmitting device is located at its current position).

For some implementations, the transmitting device may determine a displacement vector corresponding to a direction and/or distance of movement (e.g., from a previous position to the current position), and may further communicate the displacement vector to one or more receiving devices. For some other implementations, a receiving device may determine the displacement vector of the transmitting device based on the previous AoA/AoD information (e.g., estimated when the transmitting device was located at a previous position) and the current AoA/AoD information (e.g., estimated when the transmitting device is located at its current position). A receiving device may improve its position estimation by applying the displacement vector to a previous estimated position. In some aspects, the receiving device may use the displacement vector to improve the accuracy of its AoA and/or AoD estimates. In other aspects, the receiving device may use the displacement vector to predict AoA/AoD information for future wireless signals from the transmitting device. These and other details of such implementations, which provide one or more technical solutions to the aforementioned technical problems, are described in more detail below.

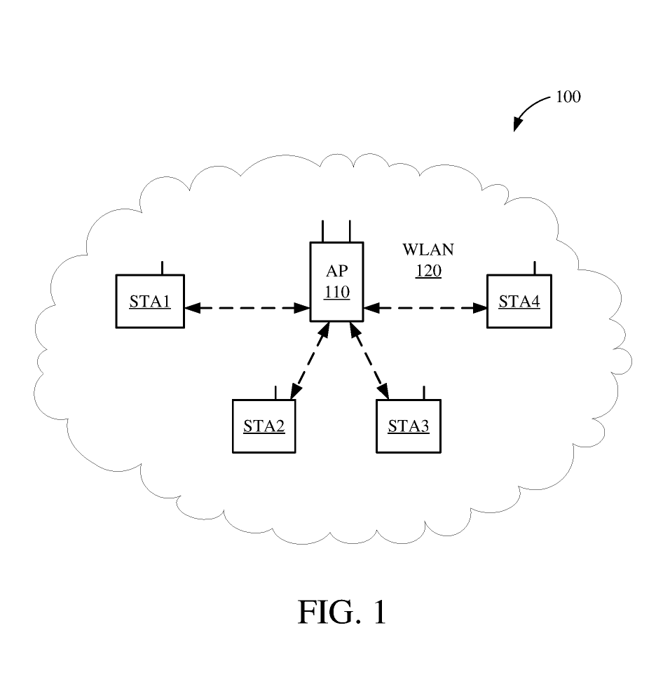

FIG. 1 shows a block diagram of an example wireless system 100 within which aspects of the present disclosure may be implemented. The wireless system 100 is shown to include four wireless stations STA1-STA4, a wireless access point (AP) 110, and a wireless local area network (WLAN) 120. The WLAN 120 may be formed by a plurality of Wi-Fi access points (APs) that may operate according to the IEEE 802.11 family of standards (or according to other suitable wireless protocols). Thus, although only one AP 110 is shown in FIG. 1 for simplicity, it is to be understood that WLAN 120 may be formed by any number of access points such as AP 110. The AP 110 may be assigned a unique MAC address that is programmed therein by, for example, the manufacturer of the access point. Similarly, each of stations STA1-STA4 is also assigned a unique MAC address. Although not specifically shown in FIG. 1, for at least some implementations, the stations STA1-STA4 may exchange signals directly with each other (e.g., without the presence of AP 110).

For some implementations, the wireless system 100 may correspond to a multiple-input multiple-output (MIMO) wireless network, and may support single-user MIMO (SU-MIMO) and multi-user MIMO (MU-MIMO) communications. Further, although the WLAN 120 is depicted in FIG. 1 as an infrastructure Basic Service Set (BSS), for other implementations, WLAN 120 may be an Independent Basic Service Set (IBSS), an Extended Basic Service Set (EBSS), an ad-hoc network, or a peer-to-peer (P2P) network (e.g., operating according to the Wi-Fi Direct protocols).

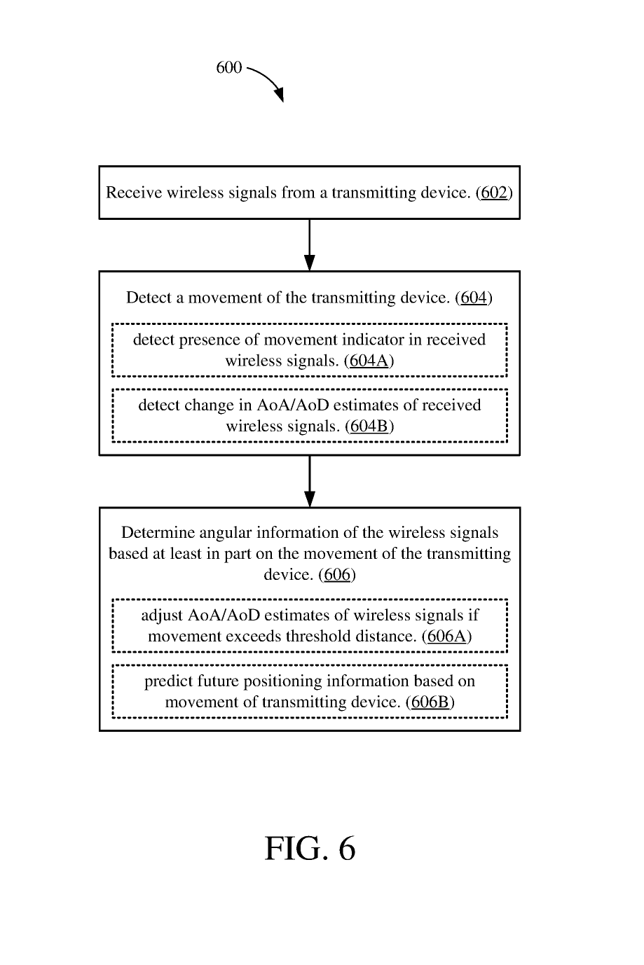

The stations STA1-STA4 may be any suitable Wi-Fi enabled wireless devices including, for example, cell phones, personal digital assistants (PDAs), tablet devices, laptop computers, or the like. The stations STA1-STA4 may also be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some implementations, each of stations STA1-STA4 may include a transceiver, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 6-8.

The AP 110 may be any suitable device that allows one or more wireless devices to connect to a network (e.g., a local area network (LAN), wide area network (WAN), metropolitan area network (MAN), and/or the Internet) via AP 110 using Wi-Fi, Bluetooth, or any other suitable wireless communication standards. For at least some implementations, AP 110 may include a transceiver, a network interface, one or more processing resources, and one or more memory sources. The memory resources may include a non-transitory computer-readable medium (e.g., one or more nonvolatile memory elements, such as EPROM, EEPROM, Flash memory, a hard drive, etc.) that stores instructions for performing operations described operations described above or below with respect to FIGS. 6-8. For other implementations, one or more functions of AP 110 may be performed by one of stations STA1-STA4 (e.g., operating as a soft AP).

For the stations STA1-STA4 and/or AP 110, the one or more transceivers may include Wi-Fi transceivers, Bluetooth transceivers, cellular transceivers, and/or other suitable radio frequency (RF) transceivers (not shown for simplicity) to transmit and receive wireless communication signals. Each transceiver may communicate with other wireless devices in distinct frequency bands and/or using distinct communication protocols. For example, the Wi-Fi transceiver may communicate within a 2.4 GHz frequency band, within a 5 GHz frequency band, and/or within a 60 GHz frequency band in accordance with the IEEE 802.11 family of standards. The cellular transceiver may communicate within various RF frequency bands in accordance with a 4G Long Term Evolution (LTE) protocol described by the 3rd Generation Partnership Project (3GPP) (e.g., between approximately 700 MHz and approximately 3.9 GHz) and/or in accordance with other cellular protocols (e.g., a Global System for Mobile (GSM) communications protocol). For other implementations, the transceivers included within the stations STA1-STA4 and/or the AP 110 may be any technically feasible transceiver such as a ZigBee transceiver described by a specification from the ZigBee specification, a WiGig transceiver, and/or a HomePlug transceiver described by a specification from the HomePlug Alliance.

AP 110 may periodically broadcast beacon frames to enable any STAs within wireless range of the AP 110 to establish and/or maintain a communication link with the wireless network 100. The beacon frames, which may include a traffic indication map (TIM) indicating whether the AP 110 has queued downlink data for the stations STA1-STA4, are typically broadcast according to a target beacon transmission time (TBTT) schedule. The broadcasted beacon frames may also include the AP's timing synchronization function (TSF) value. The stations STA1-STA4 may synchronize their own local TSF values with the broadcasted TSF value, for example, so that all the stations STA1-STA4 are synchronized with each other and the AP 110.

For at least some implementations, each of the stations STA1-STA4 and AP 110 may include RF ranging circuitry (e.g., formed using well-known software modules, hardware components, and/or a suitable combination thereof) that may be used to estimate the distance between itself and another Wi-Fi enabled device using any suitable ranging operation. In addition, each of the stations STA1-STA4 and/or AP 110 may include a local memory (not shown in FIG. 1 for simplicity) to store a cache of Wi-Fi access point and/or station data.

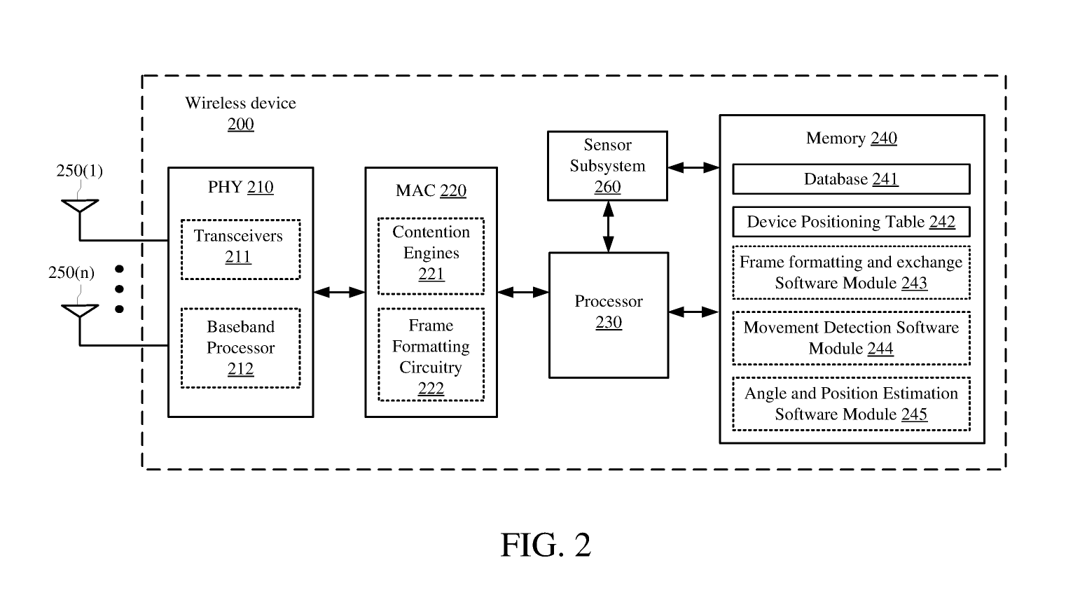

FIG. 2 shows a wireless device 200 that may be one implementation of at least one of the stations STA1-STA4 or the AP 110 of FIG. 1. The wireless device 200 may include a physical-layer device (PHY) 210, may include a medium access controller (MAC) 220, may include a processor 230, may include a memory 240, and may include a number of antennas 250(1)-250(n). The PHY 210 may include at least a number of transceivers 211 and a baseband processor 212. The transceivers 211 may be coupled to antennas 250(1)-250(n), either directly or through an antenna selection circuit (not shown for simplicity). The transceivers 211 may be used to transmit signals to and receive signals from other wireless devices including, for example, AP 110 and/or one or more of the stations STA1-STA4 of FIG. 1. Although not shown in FIG. 2 for simplicity, the transceivers 211 may include any number of transmit chains to process and transmit signals to other wireless devices via antennas 250(1)-250(n), and may include any number of receive chains to process signals received from antennas 250(1)-250(n). Thus, the wireless device 200 may be configured for MIMO operations. The MIMO operations may include SU-MIMO operations and/or MU-MIMO operations. Further, n some aspects, the wireless device 200 may use multiple antennas 250(1)-250(n) to provide antenna diversity. Antenna diversity may include polarization diversity, pattern diversity, and/or spatial diversity.

The baseband processor 212 may be used to process signals received from processor 230 and/or memory 240 and to forward the processed signals to transceivers 211 for transmission via one or more of antennas 250(1)-250(n), and may be used to process signals received from one or more of antennas 250(1)-250(n) via transceivers 211 and to forward the processed signals to processor 230 and/or memory 240.

The MAC 220 may include at least a number of contention engines 221 and frame formatting circuitry 222. The contention engines 221 may contend for access to one or more shared wireless mediums, and may also store packets for transmission over one or more shared wireless mediums. For other implementations, the contention engines 221 may be separate from MAC 220. For still other implementations, the contention engines 221 may be implemented as one or more software modules (e.g., stored in memory 240 or stored in memory provided within MAC 220) containing instructions that, when executed by processor 230, perform the functions of contention engines 221.

The frame formatting circuitry 222 may be used to create and/or format frames received from processor 230 and/or memory 240 (e.g., by adding MAC headers to PDUs provided by processor 230), and may be used to re-format frames received from PHY 210 (e.g., by stripping MAC headers from frames received from PHY 210). In some aspects, the frame formatting circuitry 222 may be used to embed a movement indicator and/or a displacement vector within packets or signals to be transmitted from wireless device 200. The movement indicator may indicate whether the wireless device 200 has moved beyond a threshold distance since a previous signal transmission to a receiving device. The displacement vector may indicate a direction and/or distance of the movement by the wireless device 200.

Sensor subsystem 260 may contain one or more sensors for detecting movement of the wireless device 200. For example, the sensor subsystem 260 may include one or more inertial sensors such as accelerometers and/or gyroscopes. Additionally, the sensor subsystem 260 may include a barometer for detecting a vertical displacement (via a pressure difference) of the wireless device 200. For some implementations, the sensor subsystem 260 may detect when the wireless device 200 has moved by a “significant” amount (e.g., a threshold distance from a previous position). Sensor subsystem 260 may be coupled to processor 230 and to memory 240.

Memory 240 may include a database 241 that may store location data, configuration information, data rates, MAC addresses, and other suitable information about (or pertaining to) a number of access points, stations, and/or other wireless devices. The database 241 may also store profile information for a number of wireless devices. The profile information for a given wireless device may include, for example, the wireless device's service set identifier (SSID), channel information, received signal strength indicator (RSSI) values, goodput values, channel state information (CSI), and connection history with wireless device 200.

Memory 240 may include a device positioning table 242 that may store device positioning information (e.g., descriptors) for one or more other devices. The device positioning information may include location information (e.g., indicating a position of another device relative to the wireless device 200), angular information (e.g., AoA and/or AoD estimates of wireless signals received from another device), movement information (e.g., indicating a direction and/or distance of movement of another device relative to the wireless device 200), and/or other information describing a relative position of one or more other devices. In some aspects, the device positioning information for a given device may be stored in the device positioning table 242 upon reception of signals transmitted from the given device and/or in response to prior signal exchanges between the wireless device 200 and the given device. In other aspects, the device positioning information for a given device may be obtained from or shared by another device (e.g., a device that previously obtained device positioning information of the given device).

Memory 240 may also include a non-transitory computer-readable storage medium (e.g., one or more nonvolatile memory elements, such as EPROM, EEPROM, Flash memory, a hard drive, and so on) that may store the following software modules:
a frame formation and exchange software module 243 to facilitate the creation and exchange of frames (e.g., data frames, control frames, management frames, and action frames), for example, as described below with respect to FIGS. 6-8;
a movement detection software module 244 to facilitate the detection of movement by the wireless device 200 (e.g., using sensor subsystem 260) or another device (e.g., a transmitting device), and/or to facilitate the generation, transmission, reception, and/or detection of movement indicators (e.g., for transmitted and received wireless signals), for example, as described below with respect to FIGS. 6-8; and
an angle and position estimation software module 245 to estimate the AoA,

AoD, and/or device positional changes associated with one or more received signals based, at least in part, on the detected movement of a transmitting device, for example, as described below with respect to FIGS. 6-8. Each software module includes instructions that, when executed by processor 230, may cause wireless device 200 to perform the corresponding functions. The non-transitory computer-readable medium of memory 240 thus includes instructions for performing all or a portion of the operations of the method of FIGS. 6-8.

Processor 230 may be one or more suitable processors capable of executing scripts or instructions of one or more software programs stored in wireless device 200 (e.g., within memory 240). For example, processor 230 may execute the frame formation and exchange software module 243 to facilitate the creation and exchange of frames (e.g., data frames, control frames, management frames, and action frames). Processor 230 may also execute the movement detection software module 244 to facilitate the detection of movement by the wireless device 200 (e.g., using sensor subsystem 260) or another device (e.g., a transmitting device), and/or to facilitate the generation, transmission, reception, and/or detection of movement indicators (e.g., for transmitted and received wireless signals). Processor 230 may also execute the angle and position estimation software module 245 to estimate the AoA, AoD, and/or device positional changes associated with one or more received signals based, at least in part, on the detected movement of a transmitting device.

A receiving device may include any number of antennas, for example, as depicted by wireless device 200 of FIG. 2. Thus, when a signal is transmitted from a transmitting device to a receiving device, the wireless signal may be received by different antennas of the receiving device at different times—and therefore with different phases—due to physical spacing between the antennas of the receiving device.

A transmitting device may also include any number of antennas, for example, as depicted by wireless device 200 of FIG. 2. Thus, when a signal is transmitted from a transmitting device to a receiving device, an antenna of the receiving device may receive a signal component from each of the transmitting device's antennas at different times—and therefore with different phases—due to physical spacing between the antennas of the transmitting device and/or phase shifts applied to the signals transmitted using different antennas.

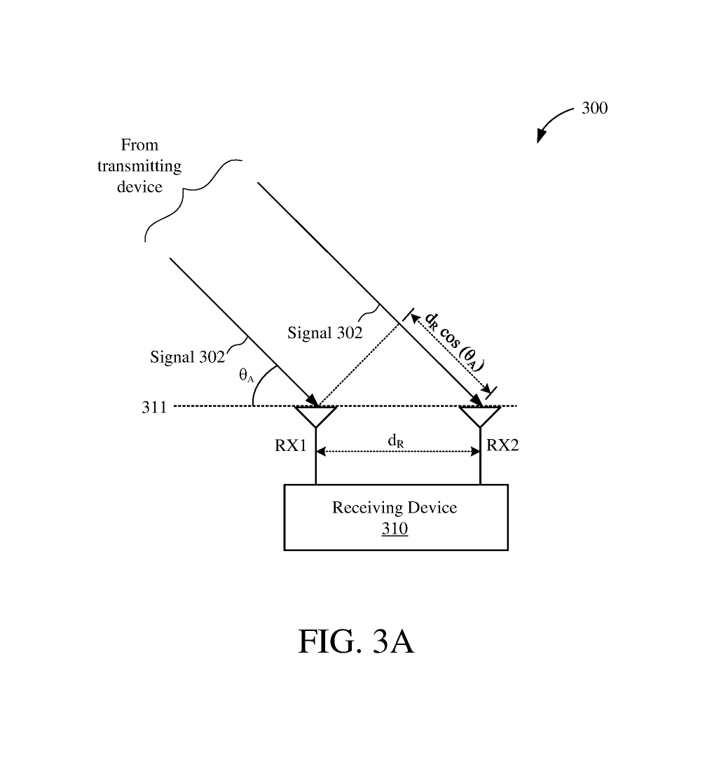

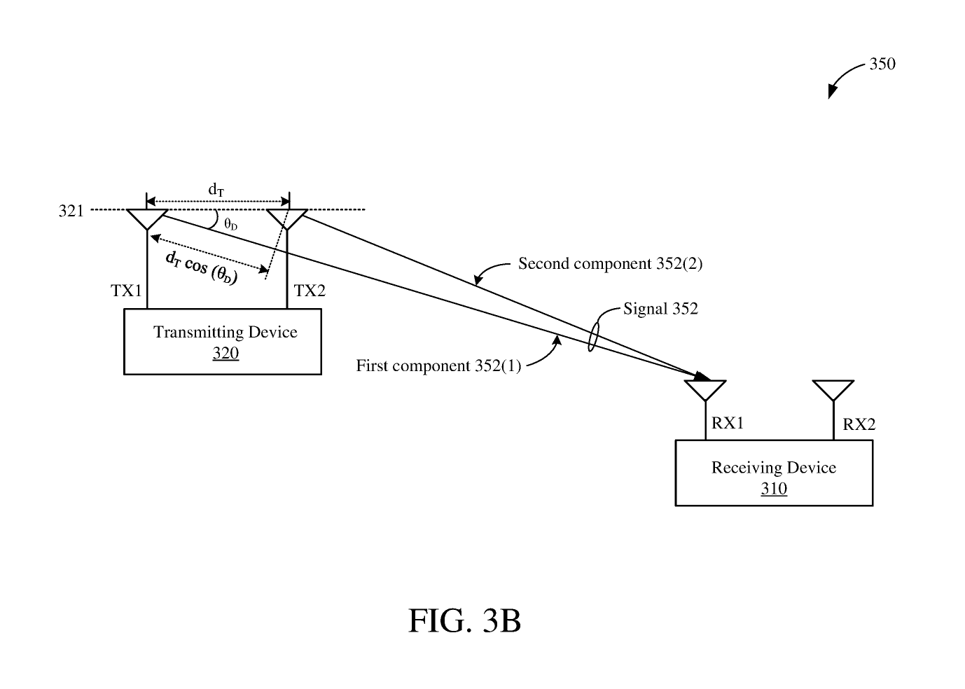

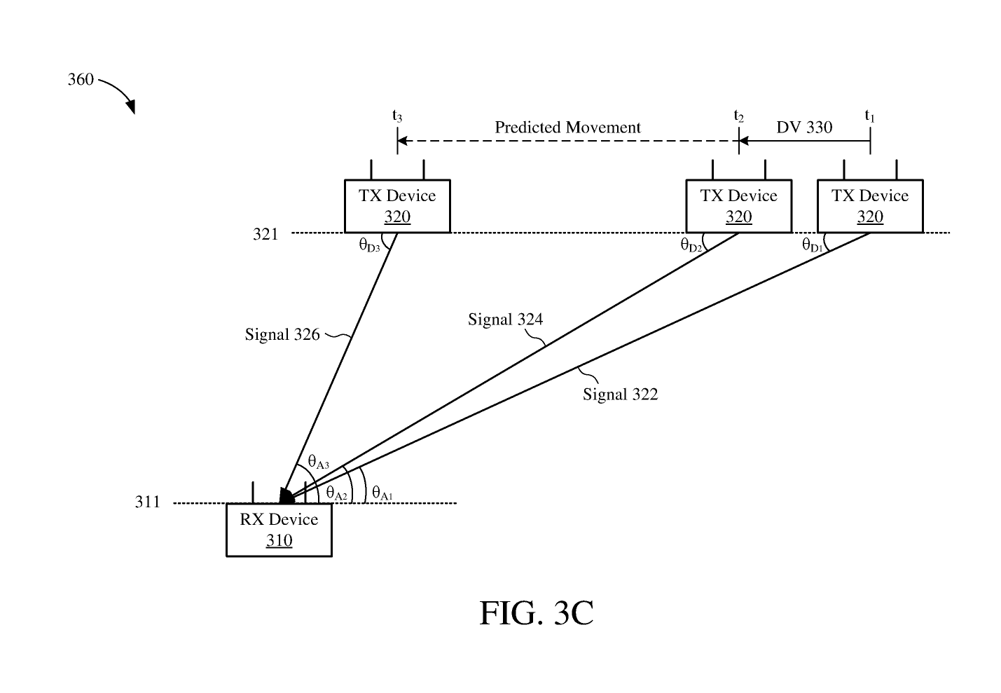

FIG. 3A is an illustration 300 depicting reception of a signal 302 by a receiving device 310 that includes two antennas RX1 and RX2 separated by a distance d_{R}. For the example of FIG. 3A, the signal 302 is received at the first antenna RX1 and the second antenna RX2 at an angle of arrival θ_{A} relative to an axis line 311 extending between the first and second antennas RX1 and RX2. Because the first and second antennas RX1 and RX2 are separated by a distance d_{R}, the signal 302 as received by the second antenna RX2 travels a distance equal to d cos θ_{A} longer than the signal 302 as received by first antenna RX1. The phase difference observed between the first and second antennas RX1 and RX2 may be expressed as:

ΔPhase=2πd_{R} cos θ_{A}/λ

where λ is the wavelength of signal 302. Assuming d≈λ/2, then this phase difference may be expressed as:

ΔPhase=π cos θ_{A}

In some aspects, the phase difference between the signal 302 as received by the first antenna RX1 and the signal 302 as received by the second antenna RX2 may be referred to as the phase information of the signal 302. Thereafter, the receiving device 310 may estimate the angle of arrival θ_{A} of the signal 302 received from the transmitting device based on the determined phase information (or phase difference) using any suitable well-known techniques.

FIG. 3B is an illustration 350 depicting transmission of a wireless signal 352 from a transmitting device 320 to the receiving device 310. The transmitting device 320 is shown to include first and second antennas TX1 and TX2 separated by a distance dT. For the example of FIG. 3B, signal 352 is transmitted from the first and second antennas TX1 and TX2 of the transmitting device 320 at a departure angle θ_{D} relative to an axis line 321 extending between the first and second antennas TX1 and TX2, and is received by the first antenna Rx1 of the receiving device 310. Because the first and second antennas TX1 and TX2 are separated by a distance d_{T}, a first component 352(1) of the signal 352 transmitted by the first antenna TX1 travels a distance equal to d_{T} cos θ_{D} longer than a second component 352(2) of the signal 352 transmitted by the second antenna TX2. The phase difference between the first component 352(1) and the second component 352(2), as observed at the first antenna RX1 of the receiving device 310, may be expressed as:

ΔPhase=2πd_{T} cos θ_{D}/λ

where λ is the wavelength of signal 312. Assuming d≈λ/2, then this phase difference may be expressed as:

ΔPhase=π cos θ_{D}

In some aspects, the phase difference between the first component 352(1) and the second component 352(2) may be referred to as the phase information of the signal 352. Thereafter, the receiving device 310 may estimate the angle of departure θ_{D} of the signal 352 from the transmitting device 320 based on the determined phase information or phase difference (ΔPhase) using any suitable well-known techniques.

It is noted that multipath signal propagation (e.g., multipath effects) may degrade the accuracy with which the receiving device 310 may estimate AoA and AoD information. One or more suitable techniques including, for example, ESPRIT (Estimation of Signal Parameters via Rotational Invariance Techniques) and MUSIC (MUltiple SIgnal Classification) or Bartlett or Capon methods may be used for estimating AoA and AoD information in the presence of multipath effects.

As discussed above, some transmitting (and receiving) devices may be mobile devices. As shown in FIGS. 3A and 3B, the AoA and AoD of received signals depends on the position of the transmitting device relative to the receiving device. Thus, movement by the receiving device (e.g., from a first position to a second position) may affect the accuracy of the AoA and AoD estimates by the receiving device. More specifically, depending on the direction and distance of movement by the transmitting device, device positioning information (e.g., AoA estimates, AoD estimates, and/or relative location information) determined at an earlier time may not accurately reflect the position of the transmitting device at a later time.

FIG. 3C is an illustration 360 depicting example transmissions of wireless signals by the transmitting (TX) device 320 while in motion. In the example of FIG. 3C, the transmitting device 320 is depicted as moving from a first position at time ti to a second position at time t₂. At time t₁, the transmitting device 320 may transmit a first signal 322 (e.g., from the first position) to the receiving device 310. The receiving device 310 may determine an AoD (θ_{D1}) and an AoA (θ_{A1}) of the first signal 322. At time t₂, the transmitting device 320 may transmit a second signal 324 (e.g., from the second position) to the receiving device 310. The receiving device 310 may determine an AoD (θ_{D2}) and an AoA (θ_{A2}) of the second signal 324.

As shown in FIG. 3C, the angular information (e.g., AoA and AoD estimates) of wireless signals received from the transmitting device 320 changes, from times t₁ to t₂, based on the movement of the transmitting device 320. Thus, depending on application, it may be desirable for the receiving device 310 to update the AoA and/or AoD information to reflect the most current position of the transmitting device 320. For example, in some applications (e.g., that don't require very fine granularity in position estimation), the change in angular information may not be significant enough to determine new AoA and/or AoD estimates at time t₂. In other words, the angular information of the first signal 322 may be sufficiently similar to the angular information of the second signal 324 (e.g., the difference in angular information represents less than a threshold change in angular position), such that the prior AoA and AoD estimates θ_{A1} and θ_{D1} may still be used to reliably describe the second signal 324 at time t₂. However, in other applications (e.g., that require finer granularity in position estimation), the difference in angular information between the first signal 322 and the second signal 324 may be significant enough to necessitate updated AoA and AoD estimates θ_{A2} and θ_{D2} for the second signal 324 at time t₂.

Thus, whether the receiving device 310 adjusts or updates its angular information may depend on whether the movement of the transmitting device 320 exceeds a threshold distance. The threshold distance may be application-specific, and may vary for different transmitting and/or receiving devices. For some implementations, the threshold distance may be a predetermined distance (e.g., 1 meter, or another suitable distance). For some other implementations, the threshold distance may be a distance that is negotiated between transmitting and receiving devices (e.g., during an association procedure between an AP and a STA). Still further, in some implementations, the threshold distance may be determined according to a wireless protocol employed by the transmitting and receiving devices. For example, the threshold distance may be determined during a ranging operation between the transmitting and receiving devices.

In some aspects, the receiving device 310 may communicate the threshold distance information to the transmitting device 320 via broadcast frames such as, for example, beacon frames. In other aspects, the AP may transmit the threshold distance information to one or more receiving devices using a new broadcast management frame. The new broadcast management frames may be transmitted periodically, for example, according to a schedule (e.g., in a manner similar to the TBTTs associated with beacon transmissions). The threshold distance may be embedded within any suitable portion of the beacon frames and/or the new broadcast frames. For some implementations, the threshold distance may be embedded within an information element (IE) or a vendor-specific information element (VSIE).

In some implementations, the transmitting device 320 may determine whether it has moved at least a threshold distance since a prior signal transmission to the receiving device 310. More specifically, the transmitting device 320 may notify the receiving device 310 when it has moved beyond the threshold distance. For example, the transmitting device 320 may provide a movement indicator in one or more wireless signals (e.g., signals 322 and/or 324) transmitted to the receiving device 310. In some aspects, the movement indicator may indicate whether or not the movement of the transmitting device 320 exceeds a threshold distance. In some other aspects, the movement indicator may indicate a direction and/or distance of movement by the transmitting device 320.

The movement of the transmitting device 320, from times t₁ to t₂, may be described or characterized by a displacement vector (DV) 330. In some aspects, the transmitting device 320 may determine the displacement vector 330 by sensing or otherwise monitoring its own movement (e.g., using one or more onboard sensors, such as sensor subsystem 260 of FIG. 2). For example, the transmitting device 320 may determine its position when the first signal 322 is transmitted (e.g., at time t₁), and may later determine its position when the second signal 324 is transmitted (e.g., at time t₂). The displacement vector 330 may be calculated based on a vector difference between the two determined positions. The displacement vector 330 may be defined with respect to a predetermined reference direction such as, for example, true North. The displacement vector 330 may be defined in a two-dimensional (2D) plane or in 3-dimensional (3D) space. In some aspects, the displacement vector 330 may indicate a height displacement of the transmitting device 320 (e.g., based on barometric information). In addition, the displacement vector 330 may be supplemented by orientation information of the device (e.g., information reflecting the orientation change of the device subject to the displacement).

At time t₂, the transmitting device 320 may communicate the displacement vector 330 to the receiving device 310, for example, via the second signal 324 (e.g., as a movement indicator). The receiving device 310 may then use the displacement vector 330 to augment and/or adjust its positioning information for the transmitting device 320. For example, the receiving device 310 may determine, based on the displacement vector 330, whether the transmitting device 320 has moved at least a threshold distance since a previous signal transmission (e.g., at time t₁). Upon determining that the transmitting device 320 has moved a threshold distance, the receiving device 310 may update the AoA and/or AoD estimates for the transmitting device 320 to reflect the angular information of the second signal 324 (e.g., by replacing the angular information of the first signal 322).

In some aspects, the receiving device 310 may use the displacement vector 330 to fine-tune or adjust the AoA and/or AoD estimates of the second signal 324. For example, the receiving device 310 may more accurately determine the angular information of the second signal 324 based on knowledge of the movement of the transmitting device 320 from a previous location. In other aspects, the receiving device 310 may use the displacement vector 330 to extrapolate current positioning information for the transmitting device 320. For example, the receiving device 310 may use the displacement vector 330 to extrapolate the current location of the transmitting device 320 (e.g., at time t₂) from a previous known location of the transmitting device 320 (e.g., at time t₁). Similarly, the receiving device 310 may use the displacement vector 330 to extrapolate AoA and/or AoD estimates of the second signal 324 from AoA and/or AoD estimates of the first signal 322.

Still further, in some aspects, the receiving device 310 may use the displacement vector 330 to predict future positioning information of the transmitting device 320. In some aspects, the receiving device 310 may predict, based on the displacement vector 330, when the transmitting device 320 is likely to move a threshold distance (or another threshold distance) relative to the receiving device 310. For example, as shown in FIG. 3C, the receiving device 310 may predict that the movement of the transmitting device 320 is likely to exceed the threshold distance at time t₃. Thus, when the transmitting device 320 transmits a third signal 326 to the receiving device 310, at time t₃, the receiving device 310 may then update its angular information for the transmitting device 320 based on AoA and AoD estimates θ_{A3} and θ_{D3} of the third signal 326. In other aspects, the receiving device 310 may use the displacement vector 330 to extrapolate future positioning information for the transmitting device 320. For example, the receiving device 310 may use the displacement vector 330 to extrapolate a future location of the transmitting device 320 (e.g., at time t₃) from one or more previous known locations (e.g., at times t₁ or t₂). Similarly, the receiving device 310 may use the displacement vector 330 to extrapolate AoA and/or AoD estimates of the third signal 326 from AoA and/or AoD estimates of the first signal 322 and/or second signal 324.

In some other implementations, the receiving device 310 may determine the displacement vector 330 based on the angular information of the received signals 322 and 324. More specifically, the receiving device 310 may correlate changes in the AoA and/or AoD estimates of the received signals 322 and 324 with movements of the transmitting device 320. In some aspects, the receiving device 310 may compare the angular information (e.g., θ_{D1} and θ_{A1}) of the first signal 322 with the angular information (θ_{D2} and θ_{A2}) of the second signal 324 to determine whether the transmitting device 320 has moved at least a threshold distance relative to the receiving device 310. In other aspects, the receiving device 310 may estimate the displacement vector 330 of the transmitting device 320 based on differences between the angular information (θ_{D1} and θ_{A1}) of the first signal 322 and the angular information (θ_{D2} and θ_{A2}) of the second signal 324.

Although FIG. 3C depicts the receiving device 310 as receiving only three signals 322, 324, and 326 from the transmitting device 320 (e.g., at times t₁, t₂, and t₃, respectively), for actual implementations, the receiving device 310 may receive any number of signals transmitted by the transmitting device 320 from each of a plurality of different positions. This may increase the accuracy with which the receiving device 310 determines the positioning information (e.g., AoA estimates, AoD estimates, and/or relative location) of the transmitting device 320. In some aspects, the movements of the transmitting device 320 may be characterized by any suitable number of displacement vectors such as displacement vector 330.

The implementations described herein may improve the accuracy with which a receiving device may estimate angular information of wireless signals received from a transmitting device, for example, by allowing the transmitting device to indicate changes in its location that may affect AoA and/or AoD estimates at the receiving device (e.g., that may cause AoA and/or AoD estimates to vary by more than a threshold value). As described above, the transmitting device 320 may determine that it has moved by more than a threshold distance since a previous signal transmission to the receiving device 310, and then indicate the positional change to the receiving device 310. The transmitting device 320 may detect its motion and/or positional change using any suitable sensors such as, for example, the sensor subsystem 260 of wireless device 200 of FIG. 2.

The movement indicator, the threshold distance, and/or the displacement vector may be communicated to the receiving device(s) in any suitable manner. More specifically, the movement indicator, the threshold distance, and/or the displacement vector may be embedded (or otherwise) included within any suitable portions of packets or frames associated with wireless signals transmitted to the receiving device 310. The movement indicator may be one or more bits that indicate whether the movement of the transmitting device 320 exceeds a threshold distance (e.g., since a previous signal transmission), and the displacement vector may be a plurality of bits indicating the direction and/or distance of movement by the transmitting device 320. In some aspects, the presence of the displacement vector in a received packet may implicitly serve as a movement indicator. The receiving device 310 may decode the movement indicator to determine whether to update and/or adjust the positioning information (e.g., AoA estimates, AoD estimates, and/or relative location) of the transmitting device 320. The receiving device 310 may also decode the displacement vector to determine how to adjust or refine the AoA and/or AoD estimates based on the current or future position of the transmitting device 320.

For some implementations, the movement indicator, the threshold distance, and/or the displacement vector may be inserted within a preamble, a midamble, and/or a postamble of packets formatted, for example, in accordance with the future IEEE 802.11az standard. For such implementations, the movement indicator may also indicate whether the transmitting device 320 is compliant with the IEEE 802.11az standard. For some other implementations, the movement indicator, the threshold distance, and/or the displacement vector may be inserted within other portions of a packet including, for example, a packet's PHY header, MAC header, reserved field, one or more reserved bits within existing fields of the packet, an information element (IE), a vendor-specific information element (VSIE), and so on.

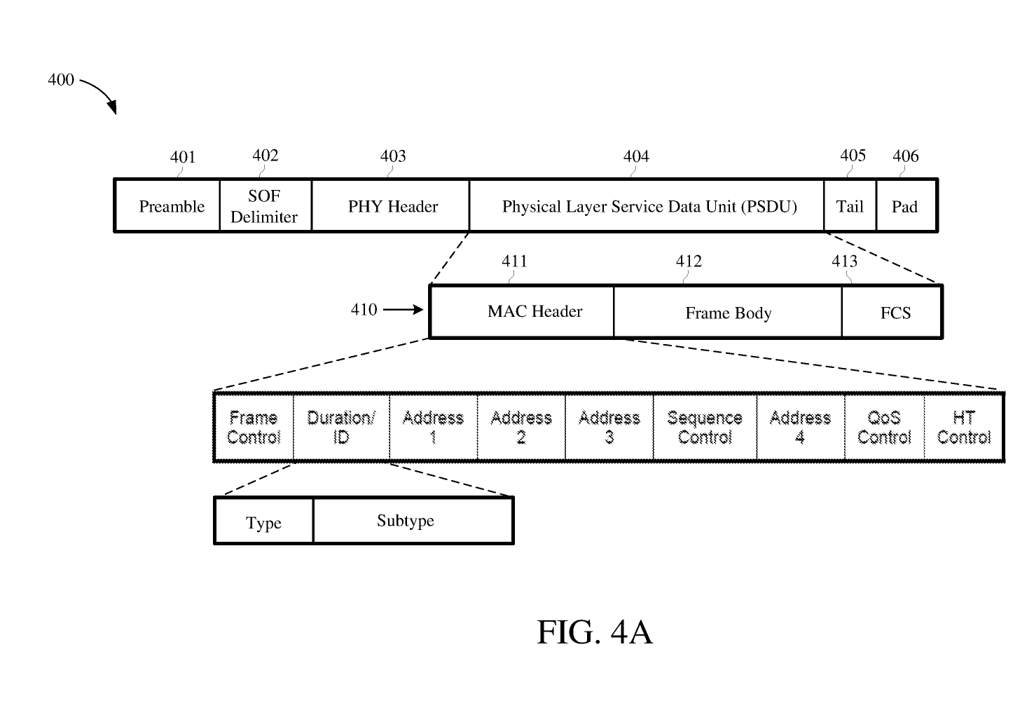

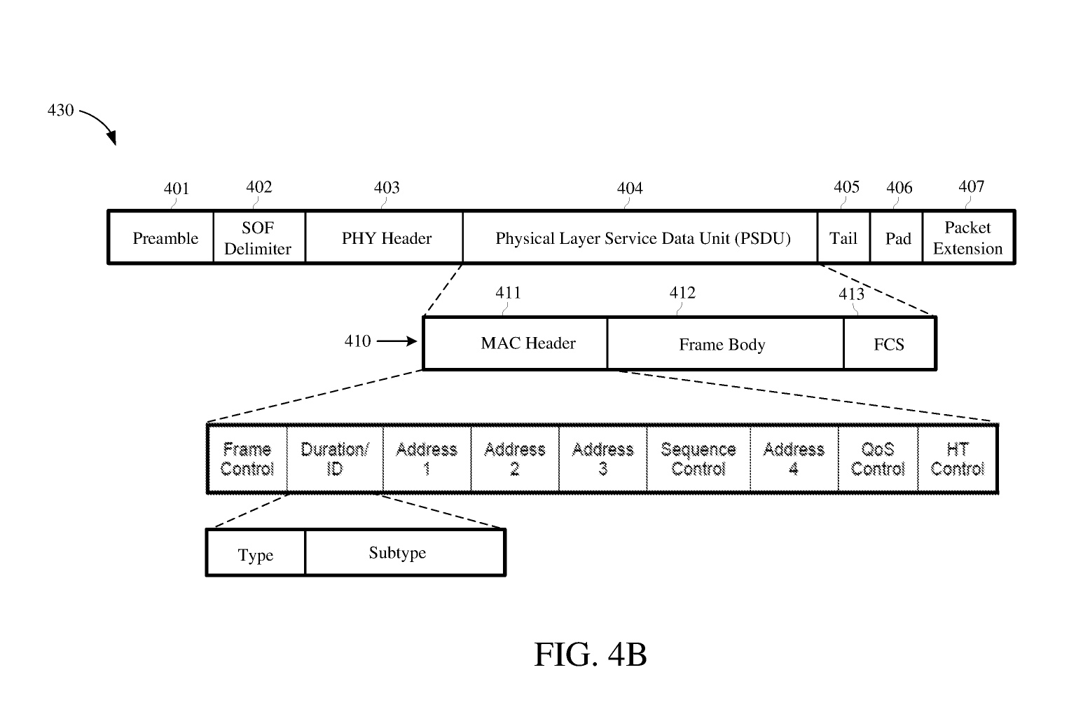

FIG. 4A shows an example packet 400 within which one or more aspects of the present disclosure may be implemented. The packet 400, which may be a VHT packet formatted in accordance with the IEEE 802.11ac standards, is shown to include a preamble 401, a start of frame (SOF) delimiter 402, a physical-layer (PHY) header 403, a Physical Layer Service Data Unit (PSDU) 404, a tail field 405, and a pad field 406.

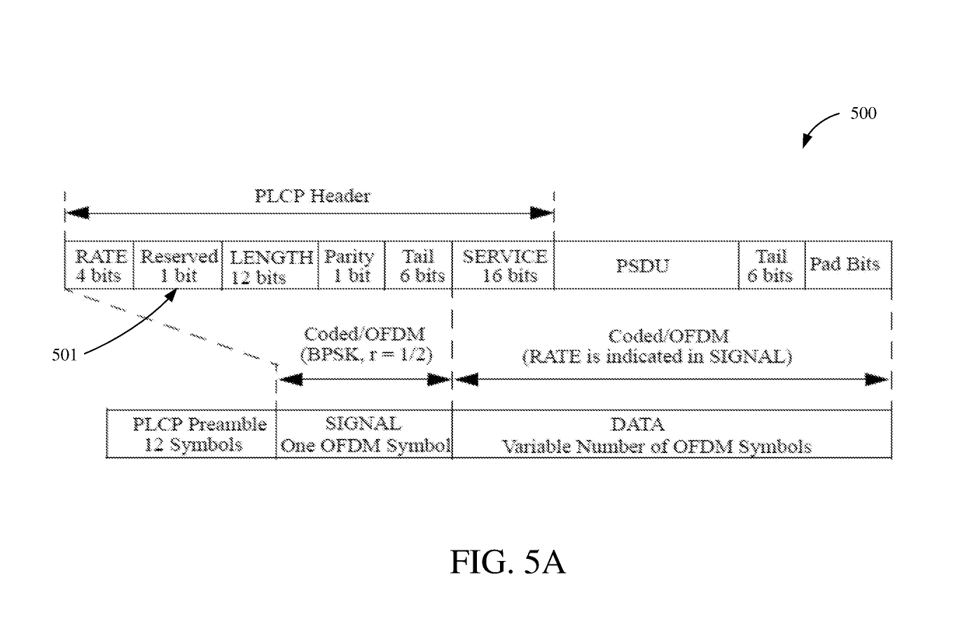

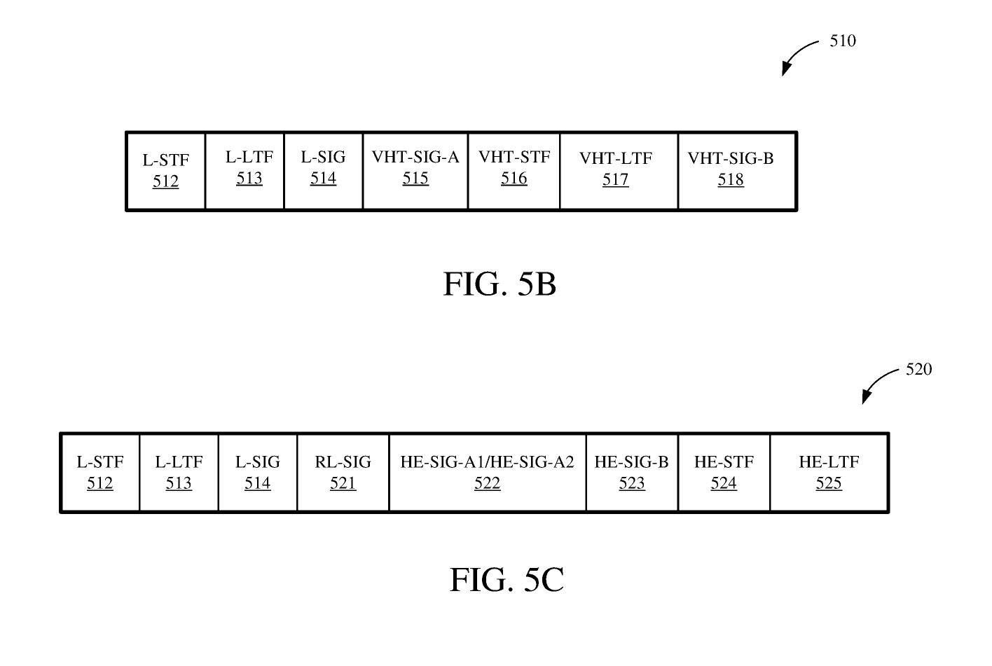

The preamble 401 may include synchronization information, timing information, frequency offset correction information, and signaling information, for example, as described in more detail below with respect to FIG. 5B. In some aspects, the preamble 401 may include a field containing a synchronization pattern (e.g., an alternating “01” pattern) that may be used to detect a potentially receivable signal, select an antenna if diversity is utilized, and determine frequency offset correction and synchronization information. The SOF delimiter 402 may indicate the start of the data frame encapsulated within the packet 400. The PHY header 403 may include a number of fields for storing data rates, a reserved bit, a length of the PSDU 404, a parity bit, a number of tail bits, and service information, as described in more detail below with respect to FIG. 5A. The PSDU 404 may contain an MPDU 410. The tail field 405 may include a number of tail bits, and the pad field 406 may include a number of pad bits.

In accordance with aspects of the present disclosure, the movement indicator, the threshold distance, and/or the displacement vector may be inserted or embedded within the preamble 401, the SOF delimiter 402, the PHY header 403, the PSDU 404, and/or the pad field 406. In some aspects, the movement indicator, the threshold distance, and/or the displacement vector may be stored together in the same field or header of packet 400. In other aspects, the movement indicator, the threshold distance, and/or the displacement vector may be stored in different fields or headers of packet 400.

The MPDU 410, which may be commonly referred to as a MAC frame, may be compliant with the IEEE 802.11 family of standards. The MPDU 410 includes a MAC header 411, a frame body 412, and a frame control sequence (FCS) field 413. The MAC header 411 may include a number of fields containing information that describes characteristics or attributes of one or more packets encapsulated with the frame body 412, may include a number of fields indicating source and destination addresses of the data encapsulated in the frame body 412, and may include a number of fields containing control information. For some implementations, MAC header 411 may be used as the MAC header of any suitable data frame, control frame, management frame, and/or action frame.

More specifically, as depicted in FIG. 4A, MAC header 411 may include a frame control field, a duration/ID field, an address 1 field, an address 2 field, an address 3 field, a sequence control field, an address 4 field, a Quality of Service (QoS) control field, and a high-throughput (HT) field. For at least some implementations, the frame control field is 2 bytes, the duration/ID field is 2 bytes, the address 1 field is 6 bytes, the address 2 field is 6 bytes, the address 3 field is 6 bytes, the sequence control field is 2 bytes, the address 4 field is 0 or 6 bytes, the QoS control field is 0 or 2 bytes, and the HT field is 0 or 4 bytes. For other implementations, the fields of the MAC header 411 of FIG. 4A may be of other suitable lengths. The frame control field may include at least a type field and a sub-type field.

FIG. 4B shows an example packet 430 within which one or more aspects of the present disclosure may be implemented. Packet 430 is similar to the example packet 400 of FIG. 4A, except that packet 430 of FIG. 4B is shown to include a packet extension 407 appended to the end of the packet 430. In some aspects, packet 430 may be a HE packet formatted in accordance with the IEEE 802.11ax standards.

The packet extension 407 does not typically store any data. Instead, the packet extension 407 typically stores “dummy” data (e.g., repeating the last symbol of the packet payload), for example, to allow a receiving device more time to decode packet 430 without giving up medium access granted to a transmitting device. For at least some implementations, the packet extension 407 may be used to store one or more sounding sequences such as, for example, sounding LTFs. Sounding LTFs may be HE-LTFs, or may be VHT-LTFs, or any LTFs that may be used for channel sounding purposes. These one or more sounding LTFs may be used by a receiving device to estimate MIMO channel conditions, which in turn may be used by the receiving device to estimate angular information for frames transmitted by a transmitting device.

FIG. 5A shows an OFDM frame 500 within which aspects of the present disclosure may be implemented. The OFDM frame 500 may be used to transport any suitable data frame, control frame, management frame, and/or action frame between wireless devices. In some aspects, the movement indicator may be the reserved bit 501 of the Physical Layer Convergence Protocol (PLCP) header of the OFDM frame 500. In other aspects, the movement indicator may be provided within the pad bits of the OFDM frame 500.

Because the reserved bit 501 of the PLCP header may be used for another purpose, it may be desirable to insert the movement indicator, the threshold distance, and/or the displacement vector into a high-throughput (HT) frame or into a very high-throughput (VHT) frame or into a High Efficiency (HE) frame.

FIG. 5B shows an example preamble 510 of a VHT packet within which aspects of the present disclosure may be implemented. The preamble 510 may be one implementation of the preamble 401 of the packet 400 of FIG. 4A and/or the preamble 401 of the packet 430 of FIG. 4B. The preamble 510, which may be compliant with the IEEE 802.11ac standards, is shown to include a Legacy Short Training Field (L-STF) 512, a Legacy Long Training Field (L-LTF) 513, a Legacy Signal (L-SIG) 514, a very-high throughput signaling A (VHT-SIG-A) field 515, a VHT-STF field 516, a VHT-LTF field 517, and a VHT-SIG-B field 518.

The L-STF 512 may include information for coarse frequency estimation, automatic gain control, and timing recovery. The L-LTF 513 may include information for fine frequency estimation, channel estimation, and fine timing recovery. The L-SIG field 514 may include modulation and coding information. The VHT-SIG-A field 515 may include parameters such as an indicated bandwidth, a payload guard interval (GI), a coding type, a number of spatial streams (Nsts), a space-time block coding (STBC), beamforming information, and so on. Information contained in the VHT-STF 516 may be used to improve automatic gain control estimates for SU-MIMO and MU-MIMO communications, and information contained in the VHT-LTF 517 may be used to estimate various MIMO channel conditions. The VHT-SIG-B field 518 may include additional SU-MIMO and MU-MIMO information including, for example, user-specific information and the number of spatial streams associated with a given frame transmission.

In some aspects, the movement indicator, the threshold distance, and/or the displacement vector may be embedded within one of the SIG fields 514 or 518 of the preamble 510, may be embedded within staggered VHT fields 515-518 of the preamble 510, may be embedded within the VHT-LTF field 517 of the preamble 510, or may be appended to the end of the preamble 510. In other aspects, the movement indicator, the threshold distance, and/or the displacement vector may be pre-pended to preamble 510, or may be provided in a field that is inserted between a pair of the fields 512-518 of preamble 510. The movement indicator, the threshold distance, and/or the displacement vector may be embedded within the scrambler-seed of the PLCP header of a packet.

The movement indicator, the threshold distance, and/or the displacement vector may be inserted into an HT preamble in a manner similar to that described above with respect to the VHT preamble 510 of FIG. 5B (except that the movement indicator, the threshold distance, and/or the displacement vector may be inserted into the HT-SIG field of the HT preamble, not shown for simplicity).

As described above, the movement indicator may indicate that a transmitting device has moved more than a threshold distance since a previous signal transmission. A receiving device may use information provided in one or more of the signaling fields (e.g., the HT-SIG field, the VHT-SIG fields, and/or the HEW-SIG field) of the received preamble 510 to detect the movement of the transmitting device. For one example, if the transmitting and receiving devices negotiate HT frame exchanges, then the receiving device may detect the movement of the transmitting device using information provided in the HT-SIG field of the specified signal. For another example, if the transmitting and receiving devices negotiate VHT frame exchanges, then the receiving device may detect the movement of the transmitting device using information provided in one of the VHT-SIG fields of the specified signal.

The receiving device may also determine a direction and/or distance of movement by the transmitting device. For example, the receiving device may determine the distance and/or direction of movement based, at least in part, on a displacement vector provided by the transmitting device. Alternatively, or in addition, the receiving device may determine the distance and/or direction of movement based on changes in the angular information of wireless signals received from the transmitting device. After identifying the distance and/or direction of movement by the transmitting device, the receiving device may more accurately estimate current angular information of wireless signals received from the transmitting device and/or predict the angular information of future wireless signals to be received from the transmitting device.

FIG. 5C shows an example preamble 520 of a HE packet within which aspects of the present disclosure may be implemented. The preamble 520 may be one implementation of the preamble 410 of the packet 400 of FIG. 4A and/or the packet 430 of FIG. 4B. The preamble 520, which may be compliant with the IEEE 802.11ax standards, is shown to include the L-STF field 512, the L-LTF field 513, and the L-SIG field 514 of preamble 510, as well as a Repeated Legacy Signal (RL-SIG) field 521, a set of HE Signal-A (HE-SIG-A1/HE-SIG-A2) fields 522, a HE Signal B (HE-SIG-B) field 523, a HE Short Training Field (HE-STF) 524, and a HE Long Training Field (HE-LTF) 525.

The RL-SIG field 521, which may be used to identify packet 520 as an HE packet, may include a time-domain waveform generated by repeating the time-domain waveform of the L-SIG field 514. The HE-SIG-A1 and HE-SIG-A2 fields 522 may include parameters such as an indicated bandwidth, a payload guard interval (GI), a coding type, a number of spatial streams (Nsts), a space-time block coding (STBC), beamforming information, and so on.

In some aspects, the HE-SIG-A1 and HE-SIG-A2 fields 955 may include a set of fields to store parameters describing the type of information stored in the HE-LTF 525 (e.g., whether the HE-LTF 525 is configured with information from which a receiving device may obtain an AoA information). For example, the set of fields includes (1) a CP+LTF Size field that stores a cyclic prefix (CP) value and a length of the HE-LTF 525; (2) an Nsts field to store information indicating the number spatial streams, (3) a STBC field store a value for space-time block coding, and (4) a transmit beamforming (TxBF) field to store information pertaining to beamforming.

The HE-SIG-B field 523 may include resource unit (RU) allocation information associated with orthogonal frequency division multiple access (OFDMA) transmissions, for example, as described in the IEEE 802.11ax specification.

Information contained in the HE-STF 524 may be used to improve automatic gain control estimates for SU-MIMO and MU-MIMO communications, and information contained in the HE-LTF 525 may be used to estimate various MIMO channel conditions. In some aspects, the HE-LTF 525 may include information (e.g., sounding sequences) from which angular information may be determined.

In some aspects, the movement indicator, the threshold distance, and/or the displacement vector may be embedded within one of the signaling fields 514 or 522 of the preamble 520, may be embedded within staggered VHT fields 515-518 of the preamble 510, or may be appended to the end of the preamble 520. In other aspects, the movement indicator, the threshold distance, and/or the displacement vector may be pre-pended to preamble 520, or may be provided in a field that is inserted between any pair of fields within the preamble 520. The movement indicator, the threshold distance, and/or the displacement vector may be embedded within the scrambler-seed of the PLCP header of a packet.

In some aspects, the movement indicator, the threshold distance, and/or the displacement vector may be included in a prior exchange of frames between a transmitting device and a receiving device. Although the prior exchange of frames may require the transmitting device and the receiving device to be associated with each other, association may provide a degree of trust between the transmitting device and the receiving device. More specifically, association between the transmitting device and the receiving device may increase privacy for the transmitting device, for example, because unassociated receiving devices may not be able to position transmitting devices as accurately as receiving devices that are associated with the transmitting device.

Still further, in some aspects, the movement indicator, the threshold distance, and/or the displacement vector may be provided from the transmitting device to the receiving device in any suitable type of frame, packet, signal, or symbol. For one example, the movement indicator, the threshold distance, and/or the displacement vector may be provided within a management frame (e.g., beacon frames, probe requests, probe responses, association requests, and so on), within a control frame (e.g., ACK frame, block ACK frame, PS-Poll frame, and so on), and/or within a data frame. The receiving device may store the movement indicator, the threshold distance, and/or the displacement vector for one or more other devices in the device positioning table 242 of FIG. 2.

Upon receiving a frame from a transmitting device, a receiving device may decode the address of the transmitting device, and use the decoded address to retrieve an entry from the device positioning table 242 corresponding to the transmitting device (e.g., by using the decoded address as a look-up value or search key). The entry retrieved from the device positioning table 242 may include an indication as to whether the transmitting device has (or is expected to have) moved beyond a threshold distance, and may include a displacement vector indicative of the direction and/or distance of movement by the transmitting device. In some aspects, the device positioning table 242 may include, for each device, an identifier (e.g., the device's MAC address, association identification (AID), IP address, and so on) and an indication as to the movement of the respective device.

In this manner, when the receiving device receives wireless signals from a transmitting device, the receiving device may determine whether it should update and/or adjust the positioning information (e.g., AoA estimates, AoD estimates, and/or relative location) of the transmitting device by accessing the device positioning table 242. For example, wireless signals received from the transmitting device prior to a significant amount of movement (e.g., beyond a threshold distance) may not accurately reflect the current position of the transmitting device, whereas wireless signals received from the transmitting device after a significant amount of movement may not accurately reflect the previous position of the transmitting device. Thus, if the transmitting device has not moved at least a threshold distance since a previous signal transmission, then the receiving device may assume that prior or existing positioning information for the transmitting device is still valid (e.g., relatively accurate). Conversely, if the transmitting device has moved beyond the threshold distance, then the receiving device may need to update and/or adjust the positioning information of the transmitting device to more accurately reflect the current position of the transmitting device.

Additionally, the receiving device may enhance its position estimates for the transmitting device by applying the displacement vector to a previously estimated position. For example, with reference to FIG. 3C, as the receiving device 310 may determine an estimated position for the transmitting device 320 at time t₁. The receiving device 310 may receive displacement vector 330 from the transmitting device 320, and may then apply the displacement vector 330 to the estimated position for the transmitting device 320 to determine estimated positions for the transmitting device 320 at time t₂ (e.g., corresponding to the current position of the transmitting device 320) and at time t₃ (e.g., corresponding to a future position of the transmitting device 320).

In accordance with some implementations, a transmitting device may also use its displacement vector to improve its positioning determinations. For example, referring again to FIG. 3C, the transmitting device 320 may estimate angular information of the first signal 322 transmitted to the receiving device 310, and may then calculate displacement vector 330 based on its movement from times t₁ to t₂. The transmitting device 320 may use the angular information of the first signal 322 and the displacement vector 330 to estimate its updated position relative to the receiving device 310 at time t₂. If the actual location of receiving device 310 is known (e.g., the receiving device 310 may signal its actual location in broadcast frames or during an association procedure with one or more stations or using management frames as defined in the IEEE 802.11revmc standards), the transmitting device 320 may estimate its actual location using the actual location of the receiving device 310 and the updated position of transmitting device 320 relative to the receiving device 310.

FIG. 6 is a flow chart depicting an example operation 600 for determining angular information of wireless signals according to aspects of the present disclosure. Although the example operation 600 is described below as being performed by a receiving device to estimate angular information of a wireless signal transmitted from a transmitting device, it is to be understood that the example operation 600 may be performed by any suitable wireless device include, for example, the AP 110 of FIG. 1, the stations STA1-STA4 of FIG. 1, or the wireless device 200 of FIG. 2.

The receiving device may receive wireless signals from the transmitting device (602). For example, the receiving device may receive the wireless signals using one or more of antennas 250(1)-250(n) and the transceivers 211 depicted in FIG. 2. For purposes of discussion herein, the wireless signals are transmitted from the transmitting device using a plurality of antennas. In some aspects, the transmitting device may be a mobile device that transmits the wireless signals to the receiving device while moving through a given environment.

The receiving device may detect a movement of the transmitting device (604). For some implementations, the receiving device may detect the movement of the transmitting device by executing the movement detection software module 244 of FIG. 2. In some aspects, the receiving device may detect the presence of a movement indicator in the received wireless signals (604A). The movement indicator may be embedded or otherwise included within any suitable portion of the received wireless signals. For one example, the movement indicator may be embedded within a preamble, midamble, or postamble of a received packet. For another example, the movement indicator may be embedded within a PHY header of the packet, a MAC header of the packet, a signaling field of the packet, or a packet extension of the packet. In other aspects, the receiving device may detect a change in the AoA and/or AoD estimates of the received wireless signals (604B). For example, the receiving device may correlate the change in AoA and/or AoD estimates with a change in position of the transmitting device.

The receiving device may then determine angular information of the wireless signals based at least in part on the movement of the transmitting device (606). For some implementations, the angular information may be determined by executing the angle and position estimation software module 245 of FIG. 2. As described above, the receiving device may determine, based on the movement indicator or changes in angular information, whether the transmitting device has moved (e.g., changed positions) by more than a threshold distance. The threshold distance may correspond to a distance of movement for which previous AoA and/or AoD estimates of received signals from the transmitting device may no longer accurately reflect the current position of the transmitting device. For some implementations, the movement indicator may include a displacement vector indicating a direction and/or distance of movement by the transmitting device.

In some aspects, the receiving device may adjust its AoA and/or AoD estimates of wireless signals from the transmitting device if the movement of the transmitting device exceeds the threshold distance (606A). For example, if the transmitting device has moved by more than the threshold distance, then the receiving device may execute the angle and position estimation software module 245 of FIG. 2 to determine current or updated AoA and/or AoD estimates for the received wireless signals (e.g., to replace any AoA and/or AoD estimates of previously-received wireless signals). In other aspects, the receiving device may predict future positioning information (e.g., AoA estimates, AoD estimates, and/or relative location) of the transmitting device based on the detected movement (606B). For example, the receiving device may use the direction and/or distance of movement of the transmitting device to extrapolate future positioning information of the transmitting device from existing or known positioning information.

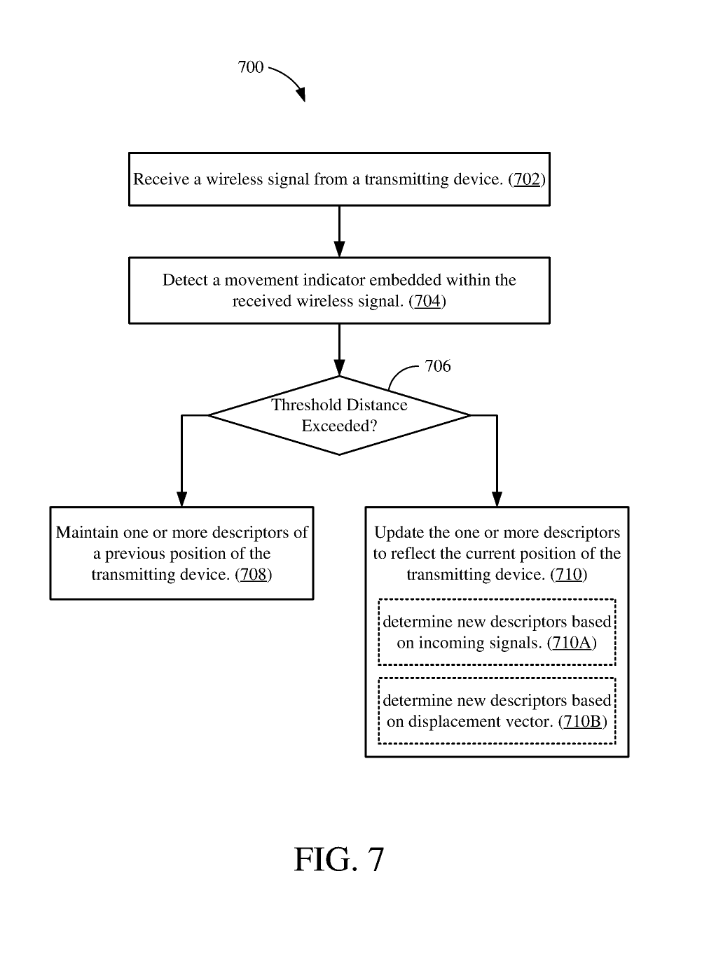

FIG. 7 is a flow chart depicting an example operation 700 for selectively adjusting the angular information of wireless signals based at least in part on movement of a transmitting device. Although the example operation 700 is described below as being performed by a receiving device to estimate angular information of a wireless signal transmitted from a transmitting device, it is to be understood that the example operation 700 may be performed by any suitable wireless device including, for example, the AP 110 of FIG. 1, the stations STA1-STA4 of FIG. 1, or the wireless device 200 of FIG. 2. In some aspects, the receiving device may be an access point, and the transmitting device may be a station associated or unassociated with the access point. In other aspects, the receiving device may be a station, and the transmitting device may be the access point. In still other aspects, the receiving device and the transmitting device may communicate directly with each other.

The receiving device may receive a wireless signal from the transmitting device (702). For example, the receiving device may receive the wireless signal using one or more of antennas 250(1)-250(n) and transceiver 211 depicted in FIG. 2. The receiving device may detect a movement indicator embedded within the received wireless signal (704), and may then decode the movement indicator to determine whether the transmitting device has moved beyond a threshold distance (706). For example, the wireless signal may include a movement indicator and/or a displacement vector indicating movements of the transmitting device (e.g., as described above with respect to FIGS. 4A-4B and 5A-5C). In some aspects, the receiving device may detect and decode the movement indicator by executing the movement detection software module 244 of FIG. 2.

If the movement of the transmitting device exceeds the threshold distance, as tested at 706, then the receiving device may continue to maintain one or more descriptors of a previous position of the transmitting device (708). For example, the one or more descriptors may correspond to positioning information (e.g., AoA estimates, AoD estimates, relative location information, etc.) that may be used to determine a position of the transmitting device. As described above, the threshold distance may correspond to a distance of movement for which previous positioning information may no longer accurately reflect the current position of the transmitting device. Thus, if the transmitting device has not moved beyond the threshold distance, then the positioning information determined based on previously-received wireless signals may still sufficiently describe the current position of the transmitting device.

Conversely, if the movement of the transmitting device does not exceed the threshold distance, as tested at 706, then the receiving device may update the one or more descriptors to reflect the current position of the transmitting device (710). For example, if the transmitting device has moved beyond the threshold distance, then the positioning information determined based on previously-received wireless signals may no longer accurately reflect the current position of the transmitting device. The receiving device may update the one or more descriptors, for example, by executing the angle and position estimation software module 245 of FIG. 2.

In some aspects, the receiving device may determine new descriptors for the current position of the transmitting device based on the incoming signal (710A). For example, the receiving device may estimate the AoA and/or AoD of the most recently-received wireless signals (e.g., as described above with respect to FIGS. 3A and 3B). In other aspects, the receiving device may determine the new descriptors for the current position of the transmitting device based on the displacement vector (710B). For example, the receiving device may use the distance and/or direction of movement of the transmitting device to extrapolate AoA and/or AoD estimates for the most recently-received wireless signals (e.g., as described above with respect to FIG. 3C). Still further, for some implementations, the receiving device may determine more accurate angular information by using the displacement vector to augment the AoA and/or AoD estimates derived from the most recently-received wireless signals (e.g., as described above with respect to FIG. 3C).

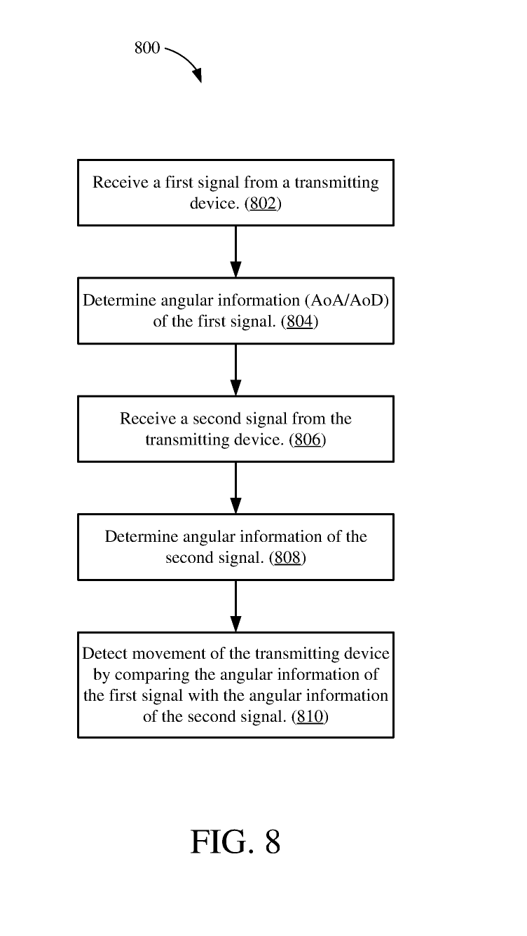

FIG. 8 is a flow chart depicting an example operation 800 for detecting movement of a transmitting device based on angular information of received wireless signals. Although the example operation 800 is described below as being performed by a receiving device to estimate angular information of a wireless signal transmitted from a transmitting device, it is to be understood that the example operation 800 may be performed by any suitable wireless device including, for example, the AP 110 of FIG. 1, the stations STA1-STA4 of FIG. 1, or the wireless device 200 of FIG. 2. In some aspects, the receiving device may be an access point, and the transmitting device may be a station associated or unassociated with the access point. In other aspects, the receiving device may be a station, and the transmitting device may be the access point. In still other aspects, the receiving device and the transmitting device may communicate directly with each other.

The receiving device may receive a first signal from the transmitting device (802), and may determine angular information (e.g., AoA and/or AoD estimates) of the first signal (804). For example, the receiving device may receive the first signal using one or more of antennas 250(1)-250(n) and transceivers 211 depicted in FIG. 2. In some aspects, the first signal may be transmitted by the transmitting device while located at a first position relative to the receiving device. The receiving device may estimate the AoA and/or AoD of the first signal, for example, by executing the angle and position estimation software module 245 of FIG. 2 (e.g., as described above with respect to FIGS. 3A and 3B).

The receiving device may then receive a second signal from the transmitting device (806), and may determine angular information (e.g., AoA and/or AoD estimates) of the second signal (808). For example, the receiving device may receive the second signal using one or more antennas 250(1)-250(n) and transceivers 211 depicted in FIG. 2. In some aspects, the second signal may be transmitted by the transmitting device while located at a second position relative to the receive device. The receiving device may estimate the AoA and/or AoD of the second signal, for example, by executing the angle and position estimation software module 245 of FIG. 2 (e.g., as described above with respect to FIGS. 3A and 3B).

Finally, the receiving device may detect a movement of the transmitting device by comparing the angular information of the first signal with the angular information of the second signal (810). For example, the receiving device may detect the movement of the transmitting device by executing the movement detection software module 244 of FIG. 2. More specifically, the receiving device may associate any changes between the angular information of the first signal and the angular information of the second signal with a detected movement of the transmitting device (e.g., as described above with respect to FIG. 3C). Thus, if there is little or no change between the angular information of the first signal and the angular information of the second signal, the receiving device may determine that the transmitting device has not moved from the time it transmitted the first signal to the time it transmitted the second signal (e.g., the first position is substantially equal to the second position). Conversely, if there is a detectable change between the angular information of the first signal and the angular information of the second signal, the receiving device may determine that the transmitting device has moved (e.g., by at least a threshold amount). In some aspects, the receiving device may correlate the difference (or degree of change) in angular information between the first signal and the second signal with a particular direction and/or distance of movement of the transmitting device (e.g., as described above with respect to FIG. 3C).

In some cases, rather than actually transmitting a frame a device may have an interface to output a frame for transmission. For example, a processor may output a frame, via a bus interface, to a radio frequency (RF) front end for transmission. Similarly, rather than actually receiving a frame, a device may have an interface to obtain a frame received from another device. For example, a processor may obtain (or receive) a frame, via a bus interface, from an RF front end for reception.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

For example, in some aspects, a means for receiving wireless signals from a transmitting device may correspond to a transceiver (e.g., transceivers 211 of FIG. 2). A means for detecting a movement of the transmitting device may correspond to a processor (e.g., execution of the movement detection software module 244 by processor 230 of FIG. 2). A means for determining angular information of the wireless signals based at least in part on the movement of the transmitting device may correspond to a processor (e.g., execution of the angle and position estimation software module 245 by processor 230 of FIG. 2).

According to certain aspects, such means may be implemented by processing systems configured to perform the corresponding functions by implementing various algorithms (e.g., in hardware or by executing software instructions) described above for generating frames for transmission during a sector sweep procedure.

As used herein, the term “generating” encompasses a wide variety of actions. For example, “generating” may include calculating, causing, computing, creating, determining, processing, deriving, investigating, making, producing, providing, giving rise to, leading to, resulting in, looking up (e.g., looking up in a table, a database or another data structure), ascertaining and the like. Also, “generating” may include receiving (e.g., receiving information), accessing (e.g., accessing data in a memory) and the like. Also, “generating” may include resolving, selecting, choosing, establishing and the like.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Also, “determining” may include measuring, estimating and the like.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any such list including multiples of the same members (e.g., any lists that include aa, bb, or cc).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface (in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method of determining angular information of wireless signals received at a receiving device, the method comprising:
receiving the wireless signals from a transmitting device;
detecting a movement of the transmitting device; and
determining the angular information of the wireless signals based at least in part on the movement of the transmitting device.

2. The method of claim 1, wherein the angular information corresponds to at least one of an angle of arrival (AoA) or an angle of departure (AoD) of the wireless signals.

3. The method of claim 1, wherein the wireless signals include a first signal received at a first time and a second signal received at a second time, and the angular information is determined based on the movement of the transmitting device from the first time to the second time.

4. The method of claim 3, wherein the determining comprises:
determining the angular information based on the first signal; and
adjusting the angular information based on the second signal if the movement of the transmitting device exceeds a threshold distance.

5. The method of claim 4, wherein the threshold distance is embedded within at least one of the wireless signals or a frame previously transmitted by the transmitting device.

6. The method of claim 1, wherein the detecting comprises:
receiving a movement indicator indicating at least one of a distance or a direction of movement of the transmitting device.

7. The method of claim 6, wherein the movement indicator is embedded within at least one of a preamble, a midamble, a postamble, or a header of a frame associated with the wireless signals.

8. The method of claim 6, wherein the movement indicator is embedded within a preamble signaling field of at least one of a high-throughput (HT) frame, a very high-throughput (VHT) frame, or a high efficiency (HE) frame associated with the wireless signals.

9. The method of claim 6, wherein the movement indicator comprises at least one of a two-dimensional vector, a three-dimensional vector, a translation component, a rotation component, or barometric information.

10. The method of claim 1, further comprising:
predicting angular information of future wireless signals from the transmitting device based at least in part on the detected movement.

11. A receiving device, comprising:
one or more processors; and
a memory storing instructions that, when executed by the one or more processors, cause the receiving device to:
receive wireless signals from a transmitting device;
detect a movement of the transmitting device; and
determine angular information of the wireless signals based at least in part on the movement of the transmitting device.

12. The receiving device of claim 11, wherein the angular information corresponds to at least one of an angle of arrival (AoA) or an angle of departure (AoD) of the wireless signals.

13. The receiving device of claim 11, wherein the wireless signals include a first signal received at a first time and a second signal received at a second time, and the angular information is determined based on the movement of the transmitting device from the first time to the second time.

14. The receiving device of claim 13, wherein execution of the instructions to determine the angular information causes the receiving device to:
determine the angular information based on the first signal; and
adjust the angular information based on the second signal if the movement of the transmitting device exceeds a threshold distance.

15. The receiving device of claim 14, wherein the threshold distance is embedded within at least one of the wireless signals or a frame previously transmitted by the transmitting device.

16. The receiving device of claim 11, wherein execution of the instructions to detect the movement of the transmitting device causes the receiving device to:
receive a movement indicator indicating at least one of a distance or a direction of movement of the transmitting device.

17. The receiving device of claim 16, wherein the movement indicator is embedded within at least one of a preamble, a midamble, a postamble, or a header of a frame associated with the wireless signals.

18. The receiving device of claim 16, wherein the movement indicator is embedded within a preamble signaling field of at least one of a high-throughput (HT) frame, a very high-throughput (VHT) frame, or a high efficiency (HE) frame associated with the wireless signals.

19. The receiving device of claim 16, wherein the movement indicator comprises at least one of a two-dimensional vector, a three-dimensional vector, a translation component, a rotation component, or barometric information.

20. The receiving device of claim 11, wherein execution of the instructions further causes the receiving device to:
predict angular information of future wireless signals from the transmitting device based at least in part on the detected movement.

21. A non-transitory computer-readable medium comprising instructions that, when executed by one or more processors of a receiving device, cause the receiving device to perform operations comprising:
receiving wireless signals from a transmitting device;
detecting a movement of the transmitting device; and
determining angular information of the wireless signals based at least in part on the movement of the transmitting device.

22. The non-transitory computer-readable medium of claim 21, wherein the wireless signals include a first signal received at a first time and a second signal received at a second time, and the angular information is determined based on the movement of the transmitting device from the first time to the second time.

23. The non-transitory computer-readable medium of claim 22, wherein execution of the instructions for determining the angular information causes the receiving device to perform operations comprising:
determining the angular information based on the first signal; and
adjusting the angular information based on the second signal if the movement of the transmitting device exceeds a threshold distance.

24. The non-transitory computer-readable medium of claim 21, wherein execution of the instructions for detecting the movement of the transmitting device causes the receiving device to perform operations comprising:
receiving a movement indicator indicating at least one of a distance or a direction of movement of the transmitting device, the movement indicator comprising at least one of a two-dimensional vector, a three-dimensional vector, a translation component, a rotation component, or barometric information.

25. The non-transitory computer-readable medium of claim 21, wherein execution of the instructions further causes the receiving device to perform operations comprising:
predicting angular information of future wireless signals from the transmitting device based at least in part on the detected movement.

26. A receiving device, comprising:
means for receiving wireless signals from a transmitting device;
means for detecting a movement of the transmitting device; and
means for determining angular information of the wireless signals based at least in part on the movement of the transmitting device.

27. The receiving device of claim 26, wherein the wireless signals include a first signal received at a first time and a second signal received at a second time, and the angular information is determined based on the movement of the transmitting device from the first time to the second time.

28. The receiving device of claim 27, wherein the means for determining the angular information of the wireless signals comprises:
means for determining the angular information based on the first signal; and
means for adjusting the angular information based on the second signal if the movement of the transmitting device exceeds a threshold distance.

29. The receiving device of claim 26, wherein the means for detecting the movement of the transmitting device comprises:
means for receiving a movement indicator indicating at least one of a distance or a direction of movement of the transmitting device, the movement indicator comprising at least one of a two-dimensional vector, a three-dimensional vector, a translation component, a rotation component, or barometric information.

30. The receiving device of claim 26, further comprising:
means for predicting angular information of future wireless signals from the transmitting device based at least in part on the detected movement.
